(19) United States
(12) Patent Application Publication
(10) Pub. No.: US 2003/0126434 A1
(43) Pub. Date: Jul. 3, 2003

(54) File security system using a security class and method for managing an encryption key

(76) Inventors: Jae Deok Lim, Daegu (KR); Joon Suk Yu, Ansan-si (KR); Sung Kyong Un, Daejeon (KR); Jong-Gook Ko, Daejeon (KR); So-Young Doo, Daejeon (KR); Jeong Nyeo Kim, Daejeon (KR)

Correspondence Address: JACOBSON HOLMAN PLLC, 400 SEVENTH STREET N.W., SUITE 600, WASHINGTON, DC, 20004, US

(21) Appl. No.: 10/232,748

(22) Filed: Sep. 3, 2002

(30) Foreign Application Priority Data
Dec. 27, 2001 (KR) 2001-85757

(51) Int. Cl. H04L 9/00

(52) U.S. Cl. 713/164

(57) ABSTRACT

A file security system uses a security class set by an access control module. The file security system includes a disk, a kernel memory and an encryption file system. The disk includes a key file in which an encryption key corresponding to the security class is stored and a file encoded by the encryption key. The encryption key stored in the disk is loaded into the kernel memory when the file security system starts operating. The encryption file system extracts an encryption key corresponding to a security class of a file that a user intends to read or store; decodes or encodes the file by using the extracted encryption key; and then provides the decoded file to the user or stores the encoded file in the disk.

### FIELD OF THE INVENTION

The present invention relates to a file system; and, more particularly, to a file security system for encoding/decoding a file requested by a user by using an encryption key based on a security class of the file set by an access control module, and a method for managing the encryption key.

### BACKGROUND OF THE INVENTION

Benefited from a rapid development of Internet, E-mail and diverse digital storage systems, one can find and obtain desired information easily and speedily.

In particular, a local area network (LAN) or a knowledge management system (KMS) has been rapidly introduced to a business environment, so that information and data within a company can be readily shared and exchanged between members of the company. Such easy access to the information, however, has increased a risk of information leakage as well. In fact, there are found ever more increased cases where employees of a certain company illegally sell the company's top-secret information when they retire or move to another company.

As such, there has been intensified a demand for a technology capable of protecting data files. To keep up with such a demand, many researches have been conducted to develop a technology and a service system for preventing an illegal distribution and an unauthorized use of information.

One among various file protection technologies is a file encryption technique using an encryption key. In a conventional encryption file system, a key is created for each of users by using user information, i.e., a user identification or a user password. Though this conventional encryption file system has an advantage in that files therein exhibit high security characteristics, the system also reveals a drawback in that files therein produced by a certain user cannot be shared by another one since the files are closed. Further, since a key should be generated or deleted according to a generation or deletion of a user, the conventional encryption file system is excessively complicated.

In another type of a conventional encryption file system, a key management is performed based on file information, e.g., an earliest generation time of a file and a file number. However, since a round key should be calculated for a key to be used for a certain file in order to encode or decode the file, operational costs in this system may be excessively increased in case many files are involved.

In the above-described conventional encryption file systems, a key for use in encoding a file may be allotted to every user, every group of users or every system. In case all the files are encoded by using just one key, the files in the system may not be protected if the key is known to the outside. If a key is allocated to each of the users, on the other hand, as in most of current encryption file systems, it becomes very difficult to share a file between a plurality of users though the file of each user can be safely protected from another user's access. Further, since a key should be generated or deleted according to a generation or a deletion of a user, the required work amount is increased. Meanwhile, if a key is allocated to each group of users, files can be shared between the users who belong to the same group. In this case, however, it is difficult to protect data having a high security class since files are encoded by the one key regardless of security classes thereof. To be more specific, there exist a plurality of users having different security classes in a group. However, since the users belonging to the same group use an identical encryption key, even the users in a low security class can access a file having a high security class produced by a user in a high security class.

### SUMMARY OF THE INVENTION

It is, therefore, an object of the present invention to provide a file security system capable of encoding or decoding a file by using an encryption key corresponding to a security class of the file.

It is another object of the present invention to provide a method for managing an encryption key in a file security system using a security class.

In accordance with one aspect of the invention, there is provided a file security system using a security class set by an access control module, including: a disk including a key file in which an encryption key corresponding to the security class is stored and a file encoded by using the encryption key; a kernel memory into which the encryption key stored in the disk is loaded when the file security system starts operating; and an encryption file system for extracting from the kernel memory an encryption key corresponding to a security class of a file that a user intends to read or store; decoding or encoding the file by using the extracted encryption key; and then transmitting the decoded file to the user or storing the encoded file in the disk.

In accordance with another aspect of the invention, there is provided a method for managing an encryption key in a file security system including an access control module for defining a security class and a disk having therein both an encryption key corresponding to the security class and a file encoded by the encryption key, the method including the steps of: (a) generating a key ID file having a predetermined key ID and generating an encryption key corresponding to the security class specified in the key ID in response to an encryption key generation request from a security manager; (b) generating a round key corresponding to the encryption key stored in the disk when the file security system starts operating and loading the generated round key into a kernel memory of the file security system; and (c) extracting from the kernel memory an encryption key corresponding to a security class of a file that a user wants to read or store; decoding or encoding the file by using the extracted encryption key; and providing the decoded file to the user or storing the encoded file in the disk.

### BRIEF DESCRIPTION OF THE DRAWINGS

The above and other objects and features of the invention will become apparent from the following description of preferred embodiments given in conjunction with accompanying drawings, in which:

FIG. 1 provides a block diagram of a file security system using a security class in accordance with the present invention;

FIG. 2 illustrates a meta-information structure of a file stored in a disk and having therein encryption key information in accordance with the present invention;

FIG. 3 describes contents of a key file including therein an encryption key based on a security class in accordance with the present invention;

FIGS. 4A and 4B respectively depict a block diagram of a process for loading an encryption key into a kernel memory and a drawing for showing a round key loaded in the kernel memory in accordance with the present invention;

FIG. 5 offers a flow chart for generating an encryption key in accordance with the present invention;

FIG. 6 sets forth a flow chart for describing both an encryption key loading process and a method for processing a file that a user desires to read in accordance with the present invention;

FIG. 7 exhibits a flow chart for processing a file that a user desires to store in accordance with the present invention; and

FIG. 8 explains a re-encoding process according to a change in a security class of a file in accordance with the present invention.

### DETAILED DESCRIPTION OF THE PREFERRED EMBODIMENTS

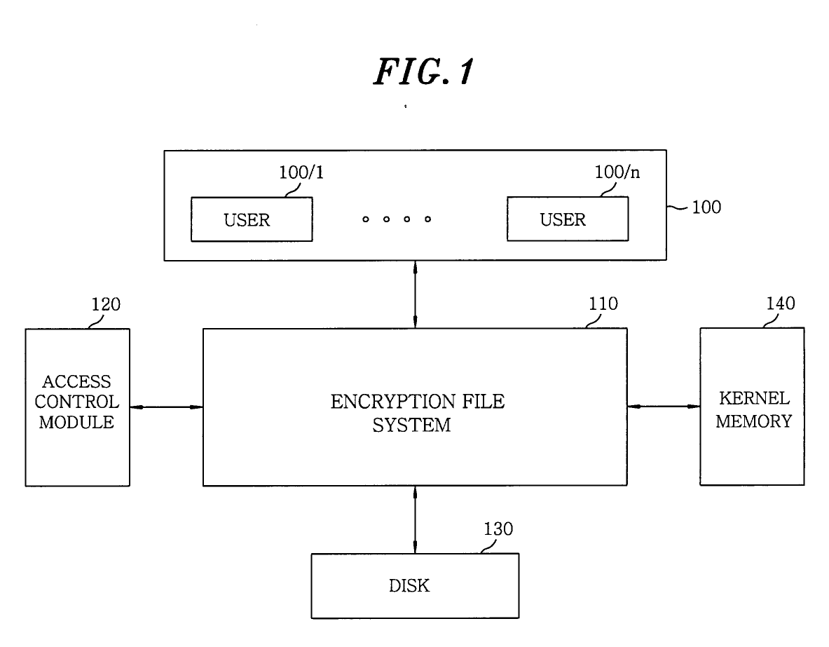

Referring to FIG. 1, there is provided a block diagram of a file security system using a security class in accordance with the present invention.

The file security system includes a plurality of users 100 (100/1 to 100/n), an encryption file system 110, an access control module 120, a disk 130 and a kernel memory 140.

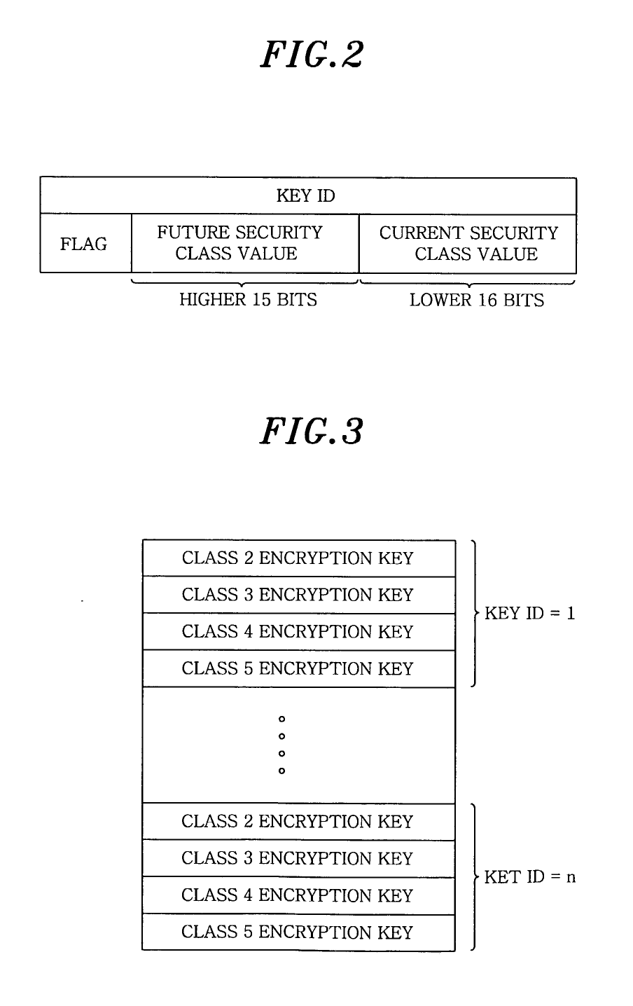

Prior to detailed description of the file security system having the above-described configuration, the structure of an encryption file stored in the disk 130 will be first explained with reference to FIG. 2. FIG. 2 illustrates a meta-information structure of a file stored in a disk and having therein encryption key information in accordance with the present invention.

In general, a file stored in the disk 130 includes therein contents and a meta-information structure in which encryption key information is stored. The meta-information structure enables the encryption file system to find the contents of the file. The encryption key information is stored at a portion within the meta-information structure that is not occupied by any data and is used later to encode the contents of the file.

As shown in FIG. 2, the encryption key information stored in the meta-information structure includes a key ID, a current security class value of a file recorded in lower 16 bits, a future security class value of the file recorded in higher 15 bits, and a flag of the file recorded in a highest bit. The Key ID indicates the renewal number of an encryption key generated by a security manager. The future security class refers to a security class to which the current security class is to be changed by a command from the security manager. The flag determines whether or not the data portion of the file needs to be re-encoded before the encryption file system 10 starts to perform a re-encoding process.

The encryption file system 110 refers to the flag set in the highest bit to re-encode the data portion of the file. If the flag is set to be, for example, “1”, the encryption file system 110 senses that the future security class is set in the higher 15 bits; extracts from the kernel memory 140 an encryption key in accordance with the future security class identified in the higher 15 bits; encodes the data portion of the file by using the extracted encryption key; and, then, clears the value set in the flag. If the encryption file system 110 finds through the analysis of the meta-information of the to-be-re-encoded file that the flag is not set, the encryption file system 110 sends to the security manager a message notifying that the file cannot be re-encoded.

The encryption file system 110 can determine whether a user 100 accesses a file in order to change the security class of the file or just to read the file based on whether the flag is set or not in the meta-information structure.

The user 100 is assigned a security class defined by the encryption file system 110. The user 100 accesses the encryption file system 110 by using a terminal and can be provided with file writing (storing) and reading services based on the assigned security class. The user 100 can only access a file whose security class is lower than or equal to his own security class. If a file that the user 100 wants to read is encoded, the encoded file is then decoded by an encryption key corresponding to the security class of the file so that the user 100 can read that file. Meanwhile, a file that the user 100 desires to store (record) is stored in the disk 130 after encoded by an encryption key in coincidence with the security class of the file.

The access control module 120 provides a list of files that can be accessed by each of the users 100 having various security classes (hereinafter referred to as an accessible file list) and specifies an access right for each of the files. The encryption file system 110 can find the security class of the user 100 who accessed thereto and determine whether the user 100 can access a desired file or not by using the access control module 120.

The encryption file system 110 determines whether the user 100 can access the encoded files stored in the disk 130 based on the accessible file list and the access right information defined by the access control module 120. The encryption file system 110 also generates an encryption key for the user 100 in response to a key generation request from the security manager, and records the generated encryption key in a key file and a newly assigned corresponding key ID in a key ID file.

If the security manager requests to generate a new encryption key but there exists neither a key ID file nor a key file in the disk 130, the encryption file system 110 generates both a key ID file having a key ID of “1” and a key file where the encryption key is to be recorded.

When the security manager generates a new encryption key, a key ID file having a key ID increased by 1 from the most recently created key ID is produced and a key file is also generated if there exists no key file. The encryption file system 110 generates an encryption key for each of security classes requiring an encoding/decoding process that are defined by the access control module 120. The generated encryption keys are stored in the key file, and the key file is stored in the disk 130. The encryption keys in the key file are loaded into the kernel memory 140 by a block-encoding algorithm while the booting of the encryption file system 110 is being performed.

Meanwhile, the encryption file system 110 authenticates the user 100 or the security manager who accessed thereto. The encryption file system 110 compares the security class of a file that the user 100 intends to access with the security class of the user 100 and determines whether the user 100 is qualified to access the file. Then, the encryption file system 110 receives the access right information provided from the access control module 120 in order to allow only the security manager, among a plurality of the users 100, to control the generation and the deletion of the encryption keys as well as the re-encoding of the file.

The encryption file system 110 generates encryption keys in response to the request from the security manager; stores the generated encryption keys in the disk 130; counts the number of the keys stored in the key file in the disk 130 while the booting of the system is being progressed; calculates and initiates a round key corresponding to each of the counted keys; loads the round key into the kernel memory 140; and searches out and extracts from the disk 130 the file that the user 100 desires to read; decodes the extracted encoded file by using an encryption key corresponding to the security class of the file; and provides the decoded file to the user 100.

If the user 100 intends to store (write) a new file, the encryption file system 110 serves to encode the file by using an encryption key corresponding to the security class of the user 100. If the user 100 intends to just modify an existing file, not create a new file, on the other hand, the encryption file system 110 encodes the modified file by using an encryption key corresponding to the security class of the file recorded in the meta-information structure thereof and, then, stores the encoded file in the disk 130.

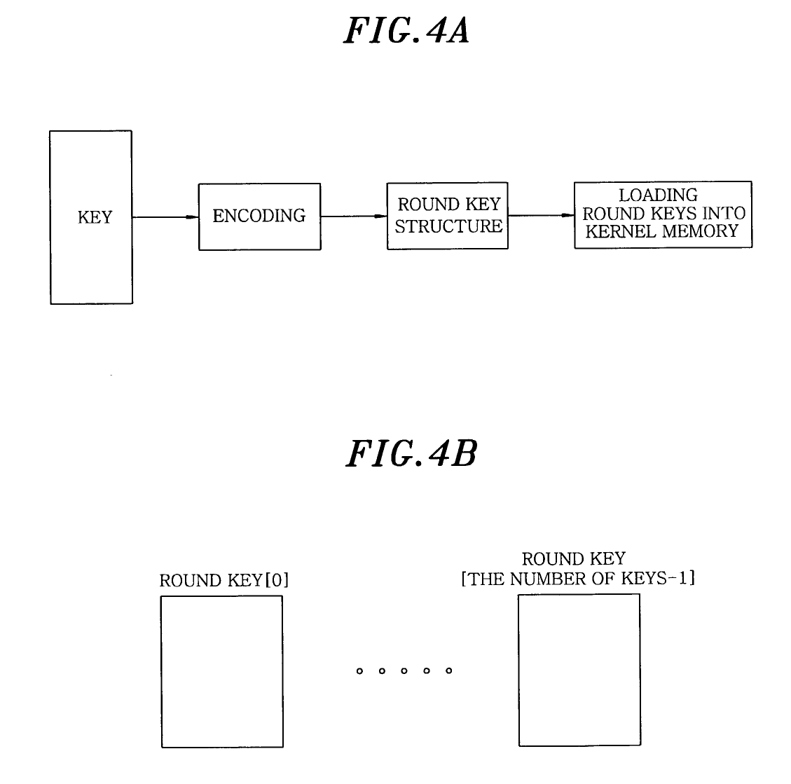

Referring to FIG. 3, the key generation process of the encryption file system 110 will now be described hereinafter.

The access control module 120 defines five different security classes. The class 0 is a default one, and the class 5 and the class 2 represent a highest security class and a lowest security class, respectively. Thus, generated for each of key IDs are only four encryption keys corresponding to the class 2 to the class 5, respectively. The number of encryption keys that can be generated at one time by a key generation command from the security manager is four as well. The encryption file system 110 stores the generated encryption keys in the key file stored in the disk 130.

As described above, four encryption keys are generated at one time by the key generation command from the security manager, and the generated encryption keys are successively stored in the key file within the disk 130. FIG. 3 shows the key file in which the encryption keys having key IDs are successively stored.

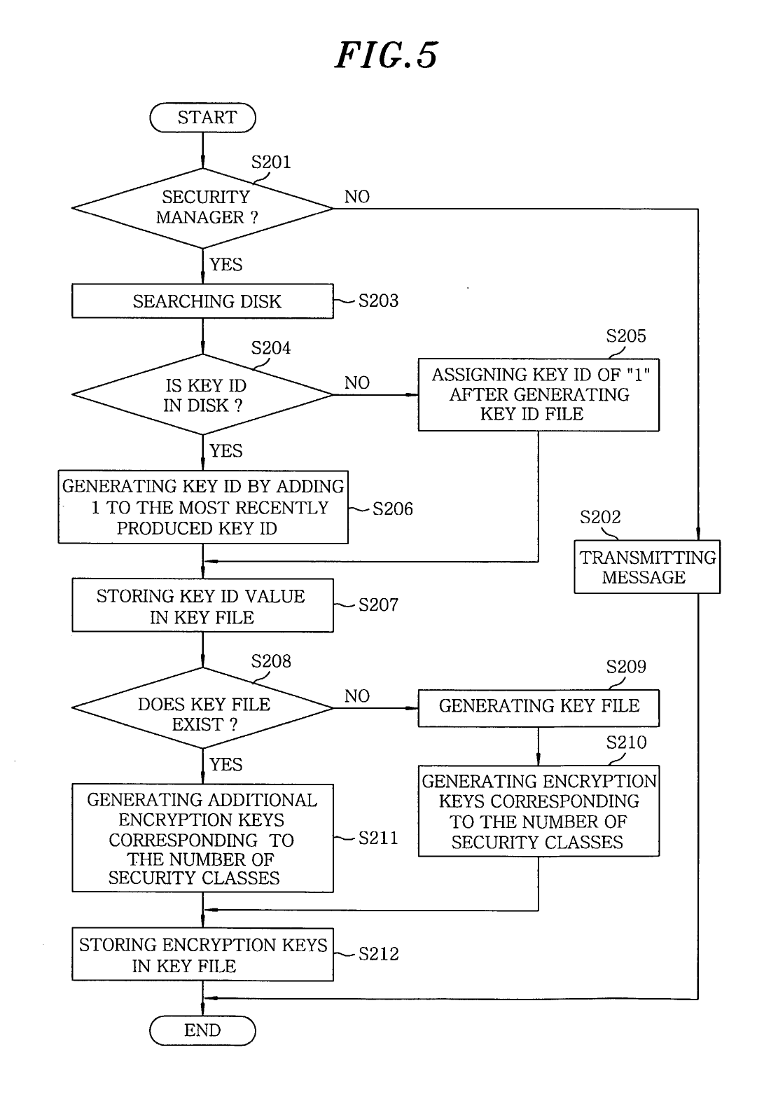

FIG. 4A shows a process for loading an encryption key into a kernel memory in accordance with the present invention and FIG. 4B illustrates a round key corresponding to the encryption key, the round key being loaded into the kernel memory.

Once operated, the encryption file system 110 estimates the number of key generation processes performed to that moment by using key IDs stored in the disk 130 and, then, stores the estimated number in the kernel memory 140 as a global variable. Then, the encryption file system 110 obtains the number of keys to be initiated by performing an operation of the number of the key generation processes and the number of the security classes that require the encoding process of the encryption file system 110. The encryption file system 110 generates a round key for each of the encryption keys by using a block-encoding algorithm and loads the generated round keys into the kernel memory 140.

The followings are more detailed description of the process for loading the round keys into the kernel memory 140. As shown in FIG. 4A, the encryption file system 110 reads the encryption keys stored in the key file one by one; calculates the round key for each of the encryption keys by using the block encoding algorithm; and loads the calculated round keys into the kernel memory 140 and arranges them as shown in FIG. 4B.

An encryption key loaded into the kernel memory 140 is used to encode or decode the file that the user 100 wants to read or store (hereinafter referred to as a desired file). The encryption key loaded in the kernel memory 140 can be found by calculating the location of the round key, wherein the location is tracked by using the security class and key ID written in the meta structure of the desired file. The encryption key loaded into the kernel memory 140 can be extracted by calculating a round key, wherein security class information and key ID information recorded in the meta-portion of the desired file are used for the round key. Then, the desired file can be encoded or decoded by using the extracted round key.

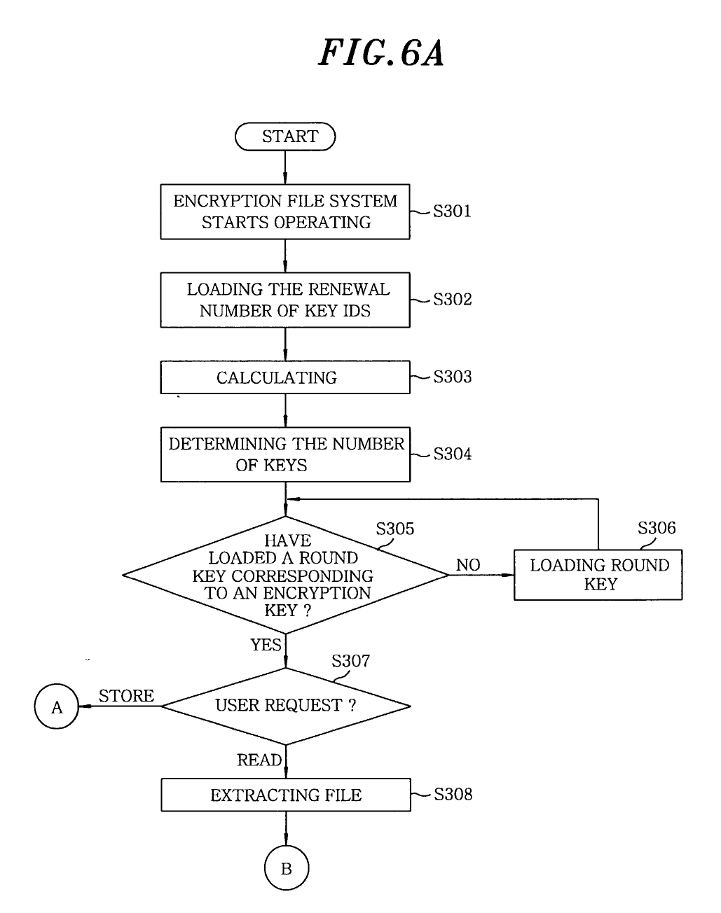

Referring to FIG. 5, there is provided a flowchart for describing an encryption key generation process by a security manager in accordance with the present invention.

The encryption file system 110 requests the access control module 120 to send thereto access right information of the user 100 and determines whether the user 100 is the security manager or not based on the received access right information (Step 201).

If it is determined in the step 201 that the user 100 who accessed the encryption file system 110 is not the security manager, the encryption file system 110 transmits a predetermined warning message to the terminal of the user 100 and terminates an encryption key generation process (Step 202).

If it is found in the step 201, on the other hand, that the role of the user 100 who accessed the encryption file system 110 to request a generation of an encryption key coincides with the security manager, the encryption file system 110 searches the disk 130 (Step 203) and determines whether or not the key ID file having the Key IDs stored therein is prepared in the disk 130 (Step 204).

If it is determined in the step 204 that the key ID file does not exist in the disk 130, the encryption file system 110 generates a key ID file in which key IDs are to be stored and assigns a key ID of the value “1” to inform that an encryption key is first generated (Step 205). Then, the encryption file system 110 stores the key ID in the key ID file (Step 207).

However, if it is determined in the step 204 that the key ID file already exists in the disk 130, the encryption file system 110 generates a new key ID by adding “1” to the most recently produced key ID (Step 206) and, then, proceeds to the step 207.

A key ID stored in the key ID file refers to the number of key generation processes performed by requests from the security manager. Since once produced encryption keys cannot be used until the validity of the encryption file system 110 expires, new encryption keys should be regularly generated at a predetermined time interval or by the judgment of the security manager for the purpose of enhancing the system security. The number of encryption key of each security class is indicated as the value of key ID.

The encryption file system 110 searches the disk 130 to determine whether there exists a key file generated by the security manager, i.e., there exists an encryption key currently being used in the encryption file system (Step 208).

If it is found in the step 208 there exists no such key file, the encryption file system 110 generates a key file (Step 209). After producing the key file, the encryption file system 110 generates encryption keys corresponding to the security classes (Step 210) and stores the generated keys in the key file (Step 212).

If it is found in the step 208 that the key file exists in the disk 130, on the other hand, the encryption file system 110 generates (an encryption key corresponding to each security class (Step 211). The generated encryption keys are successively stored in the existing key file (Step 212). The encryption key is composed of 128 bits and is utilized to calculate a round key for use in encoding/decoding a file that the user 100 wants to read or store (a desired file) and to load the calculated round key into the kernel memory 140.

The encryption keys are initiated when the encryption file system 110 starts operating or when the booting of the system is progressing. Described in this specification is a case where the encryption keys are initiated at a time when the encryption file system 110 starts to operate.

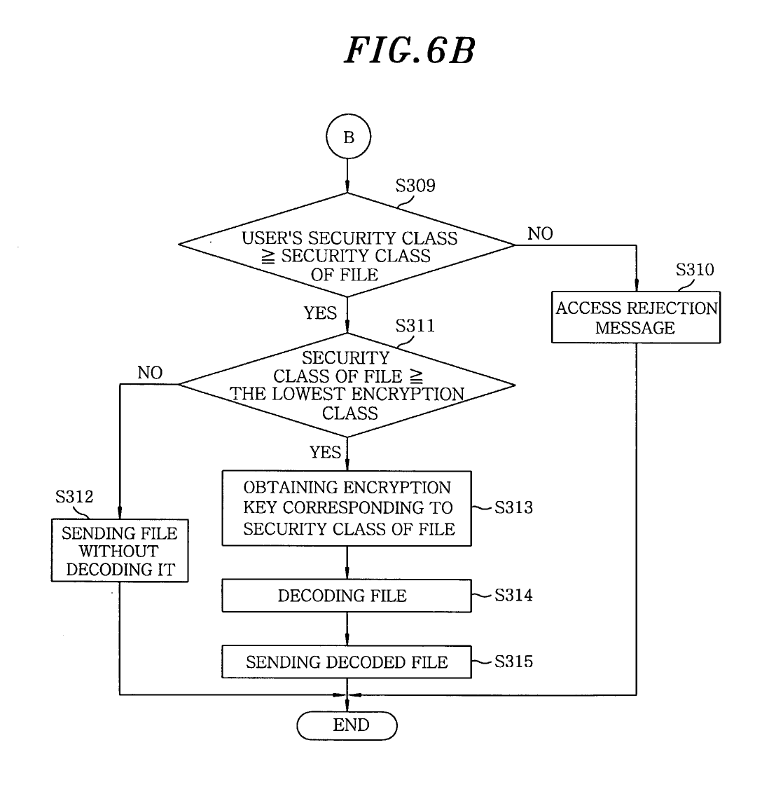

Once operated, the encryption file system 110 generates round keys corresponding to the encryption keys stored in the key file. The generated round keys are loaded in the kernel memory 140. The loading process of the encryption keys from the key file into the kernel memory 140 and the process for processing the request from the user to read or store a file will now be described hereinafter with reference to FIGS. 6A and 6B.

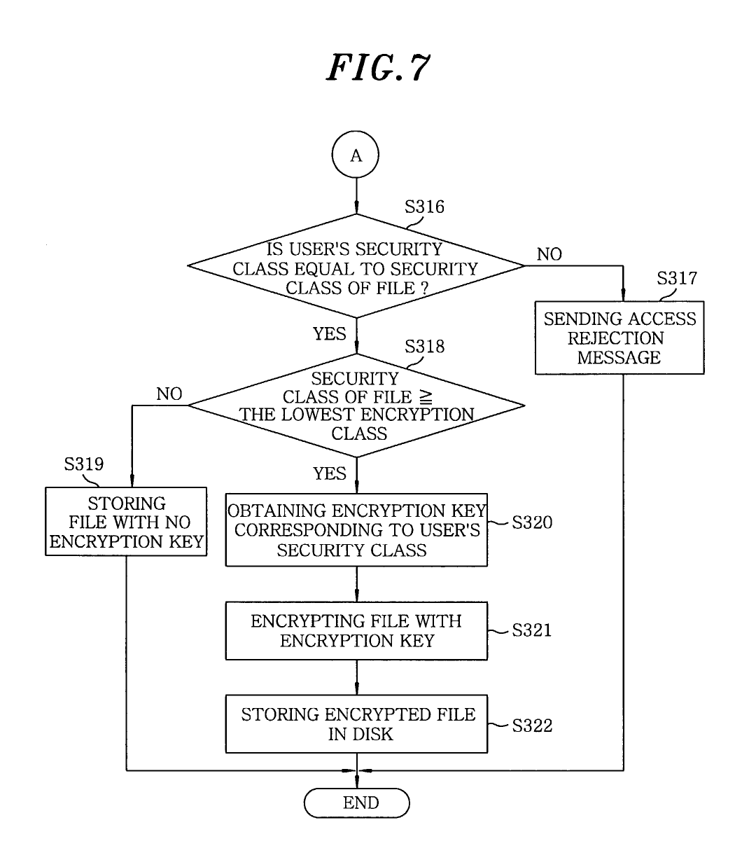

FIGS. 6A and 6B respectively describe a process for initiating the key file at a time when the encryption file system starts and a process for processing the file that the user desires to read in accordance with the present invention. FIG. 7 exhibits a flow chart for processing a file that a user desires to store in accordance with the present invention.

Once the encryption file system 110 starts, the encryption file system 110 obtains from the disk 130 the key IDs (Step 301) and loads into the kernel memory 140 the renewal number of the encryption keys as a global variable (Step 302). Then, the encryption file system 110 performs an operation of the renewal number of the encryption keys and the number of the security classes requiring the encoding process (Step 303), thereby estimating the number of the encryption keys (Step 304).

Thereafter, the encryption file system 110 determines whether or not the round keys corresponding to the encryption keys stored in the disk 130 are all loaded into the kernel memory 140 (Step 305). If it is determined in the step 305 that all the round keys corresponding to the encryption keys are not loaded in the kernel memory 140, the encryption file system 110 then keeps loading the round keys into the kernel memory 140 (Step 306).

The encryption file system 110 decodes/encodes the file that the user 100 wants to read/store by using the round keys stored in the kernel memory 140 and, then, transfers the decoded file to the terminal of the user 100 or stores the encoded file in the disk 130.

If it is found in the step 305 that the round keys corresponding to the encryption keys are loaded in the kernel memory 140, the encryption file system 110 is ready to process the user's request. The encryption file system 110 checks whether the user 100 requests to read a file stored in the disk 130 or to store therein a new/modified file (Step 307).

At this time, the encryption file system 110 receives from the access control module 120 the information that describes the file access right of the user 100.

If it is determined in the step 307 that the user 100 intends to read a file stored in the disk 130, the encryption file system 110 searches the disk 130 for information of the file requested by the user 100 (hereinafter referred to as a requested file) and reads the security class of the file (Step 308). Then, the encryption file system 110 compares the security class of the user 100 with that of the requested file (Step 309). If it is found in the step 309 that the security class of the user 100 is lower than that of the requested file, the encryption file system 110 sends an access rejection message to the user's terminal and terminates the file read process (Step 310).

On the other hand, if it is determined in the step 309 that the security class of the user 100 is equal to or higher than that of the requested file, the encryption file system 110 compares the security class of the requested file with the lowest encryption security class set by the access control module 120 (Step 311).

If it is decided in the step 311 that the security class of the requested file is lower than the lowest encryption security class, the encryption file system 110 provides the requested file to the terminal of the user 100 (step 312).

However, if it is found in the step 311 that the security class of the requested file is equal to or higher than the lowest encryption security class, i.e., if the requested file is encoded, the encryption file system 110 estimates the location of the corresponding round key by using the key ID and the security class of the requested file, and obtains the round key from the kernel memory 140 (Step 313). Next, the encryption file system 110 decodes the file retrieved from the disk 130 by using the obtained round key (Step 314) and, then, provides the decoded file to the user's terminal 100 (Step 315).

If it is revealed in the step 307 that the user 100 tries to store a file in the disk 130, the encryption file system 110 decides whether the security class of the user 100 coincides with that of the file which the user 100 wants 5 to store (hereinafter referred to as a to-be-stored file) (Step 316). In case a file is generated for the first time, the file is encoded by using an encryption key corresponding to a user's security class and then is stored in the disk 130. FIG. 6B describes a modification of contents of an existing file. If the security class of the user 100 is found in the step 316 to be different from that of the to-be-stored file, the encryption file system 110 transfers an access rejection message to the user's terminal 100 and then terminates the file storage process (Step 317).

If it is estimated in the step 316, on the other hand, that the security class of the user 100 is identical to that of the to-be-stored file, the encryption file system 110 compares the security class of the file with the lowest encryption security class set by the security manager (Step 318).

If it is found in the step 318 that the security class of the file is lower than the lowest encryption security class, the encryption file system 110 stores in the disk 130 the to-be-stored file without using an encryption key (Step 319).

On the other hand, if it is revealed in the step 318 that the security class of the file is equal to or higher than the lowest encryption security class, i.e., in case the to-be-stored file needs to be encoded, the encryption file system 110 obtains from the kernel memory 140 an encryption key corresponding to the security class of the user 100 (Step 320) and encodes the file by using the obtained encryption key (Step 321). Then, the encoded file is stored in the disk 130 (Step 322).

An encryption key which is used in encoding/decoding a file denotes a location of a round key in a kernel memory 140 which is obtained by a key ID and a file security class/a user security class.

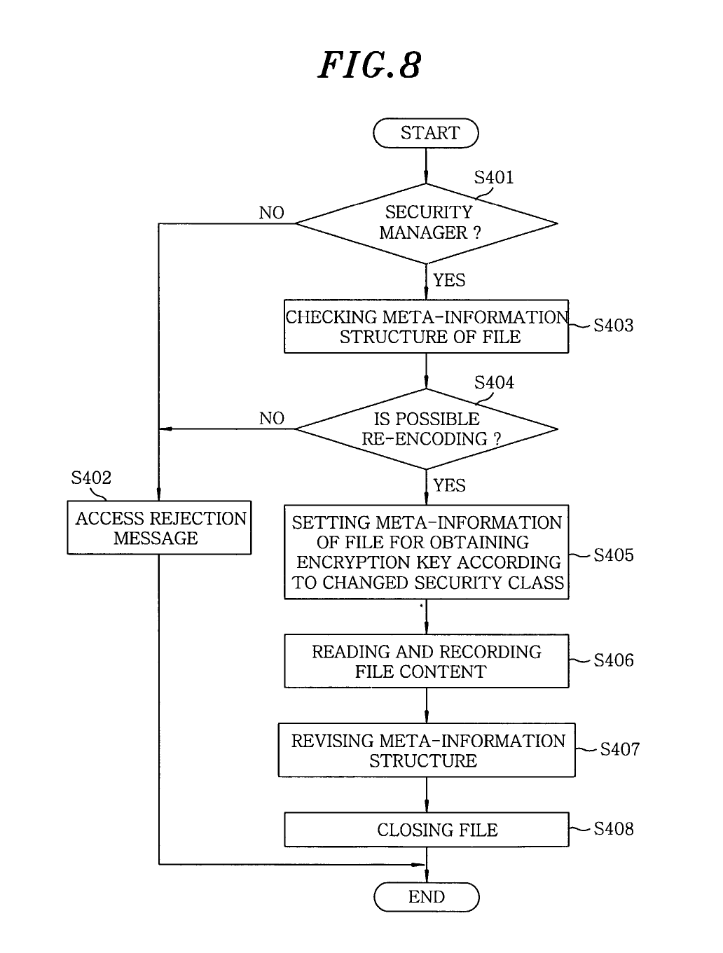

Referring to FIG. 8, there is provided a flowchart for re-encoding a file whose security class is changed in accordance with the present invention.

Only the security manager can change the security class of a file stored in the disk 130. A current security class of the file is changed into a future security class by a command from the security manager. The change in the security class of the file also causes a meta-information structure of the file, in which the security class of the file is stored, to be modified as well.

After the security class of the file is changed by the security manager, the encryption file system 110 sets a flag in the highest bit of the meta-information structure to have a value of “1” and writes the changed security class of the file in the higher 15 bits. Recorded in the lower 16 bits of the meta-information structure is the security class of the file which was valid before such a change in the security class occurs, i.e., the current security class. At this time, the contents of the file which has been encoded by the encryption key according to the current security class of the file becomes to undergo through a re-encoding process by a call from the encryption file system 110 after the security class of the file is changed.

In performing the re-encoding process of the file, the encryption file system 110 receives from the access control module 120 the security role information of the user 100 and determines whether the user 100 who has accessed the encryption file system 110 is the security manager or not (Step 401).

If it is found in the step 401 that the security role of the user 100 is not the security manager, the encryption file system 110 sends a predetermined warning message to the user's terminal and terminates an encryption key modification process (Step 402).

However, if it is determined in the step 401 that the security role of the user 100 is the security manager, the encryption file system 110 searches the disk 130 for the file to be changed by the user 100, who has a security manager role, and, then, investigates a meta-information structure therein, i.e., a portion that contains information for notifying the encryption key has been changed (Step 403).

Based on the investigation result obtained in the step 403, the encryption file system 110 determines whether the file whose encryption key is to be changed can be re-encoded or not (Step 404). If it is found in the step 404 that the file cannot be re-encoded, the encryption file system 110 transfers the predetermined warning message to the terminal of the security manager.

More specifically, the encryption file system 110 can decide whether the file can be re-encoded or not by checking whether the flag defined in FIG. 2 of the meta-information structure of the file is set to be “1” or not.

If it is found in the step 404 that the file whose encryption key is to be changed can be re-encoded, the encryption file system 110 extracts a changed security class value of the file stored in the higher 15 bits of the meta-information structure; and encodes the contents of the file by using the encryption key of changed security class loaded in the kernel memory 140, such encryption key being based on the most recent key ID (Step 406).

Thereafter, the encryption file system 110 changes the meta-information structure of the file by substituting the current security class value stored in the lower 16 bits with the changed security class value stored in the higher 15 bits. Then, the encryption file system 110 also changes the existing key ID to a recently generated key ID and clears the highest flag value (Step 407).

After the re-setting of the meta-information structure of the file, the encryption file system 110 closes the file and terminates the re-encoding process (Step 408).

As described above, the encryption keys are generated based on the security classes set by the access control module. The files that the user desires to read or store are encoded or decoded by using the encryption keys and provided to the user or stored in a disk. The number of the encryption keys used in the file security system can be estimated from the number of the security classes. Further, files having the same security class and encoded by the same encryption key can be shared between the users belonging to the same security class.

Further, if the number of the encryption keys to be used in the system is obtained, the number of the round keys corresponding to the encryption keys can also be calculated at a time when the system starts. Accordingly, it becomes unnecessary to calculate the round keys one by one before the file encoding/decoding process is performed, so that the system efficiency is greatly improved.

Still further, since the encryption key used in the encoding of the file is system-dependant rather than user-dependant, it is not required to individually manage a key for a user when the user is generated or deleted. Thus, the system operational costs can be reduced from the aspect of the key management.

Still further, in the file security system in accordance with the present invention, the encryption keys are managed based on the security classes and set the lowest encryption security class. Thus, an encryption key is not generated for a file whose security class is lower than the lowest encryption security class. That is, since the file which does not need to be encoded is distinguished from a file that is required to be encoded, a system load can be prevented and the system can become more effective and flexible.

While the invention has been shown and described with respect to the preferred embodiments, it will be understood by those skilled in the art that various changes and modifications may be made without departing from the spirit and scope of the invention as defined in the following claims.

What is claimed is:

1. A file security system using a security class set by an access control module, comprising:
a disk including a key file in which an encryption key corresponding to the security class is stored and a file encoded by using the encryption key;
a kernel memory into which the encryption key stored in the disk is loaded when the file security system starts operating; and
an encryption file system for extracting from the kernel memory an encryption key corresponding to a security class of a file that a user intends to read or store; decoding or encoding the file by using the extracted encryption key; and then transmitting the decoded file to the user or storing the encoded file in the disk.

2. The system of claim 1, wherein the encryption file system generates the encryption key corresponding to the security class of the file set by the access control module in response to an encryption key generation request from a security manager and records the generated encryption key in the key file.

3. The system of claim 2, wherein the encryption file system generates a key ID for the generated encryption key and stores the generated key ID in a key ID file.

4. The system of claim 3, wherein the generated encryption key is distinguished from an encryption key already existing in the key file in that the generated encryption key is composed of 128 bits and has the key ID different from that of the already existing encryption key.

5. The system of claim 1, wherein the key file includes lower bits having a current security class value of the file, higher bits having a security class value changed by a security manager and a flag for indicating whether or not the security class of the file is changed or not.

6. The system of claim 5, wherein the security class of the file is changed by setting the changed security class value in the higher bits and setting the flag to have a predetermined value.

7. The system of claim 6, wherein the set flag is cleared after the file is encoded by the encryption key corresponding to the security class in the higher bits, and a current security class recorded in the lower bits is replaced with that recorded in the higher bits.

8. The system of claim 1, wherein the encryption key exists just for security classes for which encoding is required, such security classes refer to from a lowest encryption security class to a highest security class set by the access control module.

9. The system of claim 1, wherein a round key corresponding to the encryption key stored in the disk is loaded into the kernel memory when the file security system starts.

10. The system of claim 1, wherein the encryption file system is characterized in that when the user generates a file that needs to be encoded, an encryption key for the generated file is included in a most recently generated key ID and corresponds to the security class of the user.

11. A method for managing an encryption key in a file security system including an access control module for defining a security class and a disk having therein both an encryption key corresponding to the security class and a file encoded by the encryption key, the method comprising the steps of:
(a) generating a key ID file having a predetermined key ID and generating an encryption key corresponding to the security class specified in the key ID in response to an encryption key generation request from a security manager;
(b) generating a round key corresponding to the encryption key stored in the disk when the file security system starts operating and loading the generated round key into a kernel memory of the file security system; and
(c) extracting from the kernel memory an encryption key corresponding to a security class of a file that a user wants to read or store; decoding or encoding the file by using the extracted encryption key; and providing the decoded file to the user or storing the encoded file in the disk.

12. The method of claim 11, wherein the encryption key generation process mentioned in the step (a) includes the stages of:
(d) searching the disk to determine whether or not the key ID file having the key ID exists in the disk;
(e) generating a key ID file having a key ID increased by “1” from a key ID stored in a most recently generated key ID file if the key ID file is found in the step (d); and
(f) generating an encryption key according to the security class defined in the generated key ID file and storing the generated encryption key in the key file of the disk.

13. The method of claim 11, wherein the number of encryption keys to be loaded into the kernel memory is obtained by performing an operation of a key ID value stored in a most recently generated key ID file and the number of security classes in which encoding is required.

14. The method of claim 11, wherein the user can read the file stored in the disk by a process including the stages of:
(g) comparing the security class of the file with that of the user;
(h) determining based on the comparison result whether or not an encryption key is required in the security class of the file if the user's security class is higher than or equal to the security class of the file;
(i) obtaining from the kernel memory the round key corresponding to the security class of the file based on the determination result and decoding the file by using the obtained round key; and
(j) providing the decoded file to the user.

15. The method of claim 11, wherein the user can store the file by a process including the stages of:
(k) comparing a security class of the file that the user wants to store with a security class of the user;
(l) determining based on the comparison result whether or not an encryption key is required in the security class of the file if the security class of the user is equal to the security class of the file;
(m) obtaining from the kernel memory a round key corresponding to the security class of the file or the user based on the determination result and encoding the file by using the obtained round key; and
(n) storing the encoded file in the disk.

16. The method of claim 11, wherein an information structure having meta-information of the file includes lower bits having a current security class value, higher bits having a security class value changed by the security manager, a key ID of the encryption key used to encode a file and a flag to be set according to a change in the security class of the file.

17. The method of claim 11, wherein the file, whose security class is changed by a security class change request from the security manager, is re-encoded by an encryption key corresponding to the changed security class.

18. The method of claim 17, wherein the file is re-encoded by a process including the stages of:
(o) determining whether or not the flag of the file whose security class is to be changed by the security manager is set;
(p) reading based on the determination result the security class of the file recorded in the higher bits of the meta-information structure of the file if the flag is found to be set;
(q) getting a most recently generated key ID from the kernel memory where the key ID is loaded when system is started; and
(r) estimating a location of the round key loaded in the kernel memory by performing an operation of the key ID and the security class value set in the higher bits and, then, re-encoding the file by using the round key existing at the estimated location.

19. The method of claim 18, further including the stages of clearing the higher bits and the flag and re-setting the key ID and the lower bits with the most recently key ID and the higher bits respectively in the meta-information structure of the re-encoded file.
